(19) United States
(12) Patent Application Publication
(10) Pub. No.: US 2025/0231077 A1
(43) Pub. Date: Jul. 17, 2025

(54) LEAK DETECTION SYSTEM WITH AUTOMATIC SHUTOFF VALVE

(71) Applicants: Curtis B. Holder, Park City, UT (US); Kevin Schomaker, Park City, UT (US)

(72) Inventors: Curtis B. Holder, Park City, UT (US); Kevin Schomaker, Park City, UT (US)

(21) Appl. No.: 18/415,001

(22) Filed: Jan. 17, 2024

(51) Int. Cl. E03D 1/32; G01M 3/32

(52) U.S. Cl. CPC E03D 1/32; G01M 3/3209

(57) ABSTRACT

A flow control device includes a control module for closing a valve in a fluid passageway in response to detection of a leak condition. The control module may determine the leak condition when a flow time of fluid in the fluid passageway meets or exceeds a preset flow time. The preset flow time may be user adjustable. The control module may be intermittently connected to an energy storage device by an automated on/off switch to conserve energy during extended periods of normal operation. A flow senor may control the on/off switch that provides the intermittent connection to power. In operation, the flow control device may be connected to a water supply line leading to a bathroom fixture, such as a toilet, to prevent overflows and prolonged leaks. Thus, the flow control device provides water conservation.

### FIELD OF THE INVENTION

The present invention relates generally to flow control and detection devices for fluid conveyance systems. More particularly, the present invention relates to automatic shut-off devices for leak prevention in fluid supply lines.

### BACKGROUND

Toilets are often the biggest culprit of high-water usage. Sometimes they leak water because the flapper valve sticks, the flapper chain is caught on something inside the tank, or parts are worn out inside the tank. Since the water flows down the sewer, leaking toilets do not necessarily leave any signs of a leak. Because leaks often go undetected, the average leaky toilet can waste about 200 gallons of water per day. That is over 6,000 gallons a month for just one leaking toilet. Some leaks may produce a running water sound that is easy to hear. Some leaks are visible as a small trickle running from the rim to the water in the bowl. Toilet leaks are often silent and can be intermittent, allowing loss of water to go undetected for long periods of time. In some cases, leaks are never detected. In other cases, leaks are only discovered after a user receives a water bill. It would therefore an improvement over the prior art to provide a flow control device that is able to automatically detect a leak condition and stop the flow of water to a leaking toilet.

### SUMMARY OF THE INVENTION

In accordance with an embodiment of the present disclosure, a flow control device for preventing leaks in a fluid conveyance system is provided. The fluid conveyance system may comprise piping, plumbing or lines that supply fluid from a source to an end user. For example, the source may be a culinary water source and the end user may be a household fixture, such as a toilet. The fluid conveyance system may provide fluid to a wide variety of under users, such as a faucet, tank, toilet, water heater, engine or machine. Typically, the end user may include a control valve such that the fluid intermittently flows during proper operation. That is, fluid flow may, at times, may be stopped. For example, water flow to a toilet is intermittent; meaning that it only flows after a flush for a short period of time to refill the tank. Thus, it will be appreciated that the present disclosure may be utilized in any fluid conveyance system where leak prevention is necessary. But, the present disclosure is particularly suited for fluid conveyance systems with intermittent flows.

In accordance with an embodiment of the present disclosure, an automated flow control device for preventing leaks in a fluid conveyance system is provided that includes a power conservation feature that only supplies power from an energy storage device to the device's control module when fluid is flowing. Thus, the control module may only be powered when fluid is flowing during normal operation or during a leak condition. It will be appreciated that this power conservation feature allows the flow control device to function for an extended period of time without the need to replace or recharge its energy storage device.

In accordance with an embodiment of the present disclosure, a flow control device for preventing leaks in a fluid conveyance system may include a housing having a fluid inlet and a fluid outlet. A fluid passageway may extend between the fluid inlet and the fluid outlet. The fluid inlet may be connected to a fluid source and the fluid outlet may be connected to a destination. The flow control device may include a valve disposed in the fluid passageway. The valve may be operable between a closed position and an open position. While in the closed position, the valve prevents flow of fluid in the fluid passageway to the destination. While in the open position, the valve permits flow of fluid in the fluid passageway to the destination. The flow control device may further include a solenoid connected to the valve. The solenoid may operate the valve between the open position and the closed position in response to control signals. The flow control device may further comprise a control module in electrical communication with the solenoid. The control module may be configured to send control signals to the solenoid to cause it to operate to open and close the valve. The control module may include a programmable microprocessor or discrete circuitry.

In an embodiment, the flow control module may further comprise an energy storage device to provide power to the control module. The energy storage device may be a battery or any other device capable of storing energy. The energy storage device may be capacitor or a super capacitor. The control module may further comprise an automatic on/off switch electrically interposed between the energy storage device and the control module. The on/off switch may be operable between an open/off position and a closed/on position. The energy storage device is disconnected from the control module while the switch is in the open/off position. The energy storage device is connected to the control module while the switch is in the closed/on position.

In an embodiment, the system may include a hydrogenerator for generating electricity to charge the energy storage device or power the control module. The hydrogenerator may comprise a hydraulic turbine located in the water flow and that converts the energy of flowing water into mechanical energy. A hydroelectric generator connected to the turbine converts this mechanical energy into electricity to charge the energy storage device and/or power the control module.

In an embodiment, the present disclosure may optionally include a radio transmitter for transmitting usage data captured by the control module. The control module may capture the water usage data and transmit it to a centralized database associated with a centralized server. In an embodiment, the radio transmitter may be one of a Bluetooth radio transmitter, a Wi-Fi radio transmitter, or a cellular transmitter (5G). The centralized server may process the data to determine optimal water usage and the number of times the device has stopped wasted water through leaks. The centralized server may analyze the usage date to optimize water flow and water usage.

In an embodiment, the control module may further include a flow sensor for operating the on/off switch to the closed position in response to fluid flow in the fluid passageway to thereby allow the energy storage device to provide power to the control module only while the fluid is flowing. In an embodiment, the on/off switch may be a magnetic reed switch. It will be appreciated that the use of the on/off switch conserves energy by preventing power flow to the control module when there is no fluid flowing in the fluid passageway.

In an embodiment, the flow sensor for controlling the application of power to the control module may include a switch responsive to water flow. In an embodiment, the switch comprises a magnetic switch responsive to water flow. The magnetic switch consists of a switch mounted to adjacent a water passage. Inside of the water passage is a first magnetic mounted on a moveable slider and operable between a first position and a second position. A second magnet is mounted opposite the switch and adjacent the water passage. When water is not flowing, the second magnet holds the moveable slider in the first position such that the switch is open. When water is flowing, it pushes the moveable slider to the second position such that the first magnet closes the switch. A closed switch indicates that water is flowing.

In an embodiment, the control module may comprise a flow timer configured to monitor a flow time of fluid in the fluid passageway. The flow time may start when fluid flow is first detected through the fluid passageway from a no-flow condition. The control module is configured to cause the solenoid to close the valve responsive to the flow time equaling or surpassing a preset flow time. In this regard, the control module may comprise an adjustment feature adjusting the preset flow time. In an embodiment, the adjustment feature automatically adjusts the preset flow time based on historical flow times. In an embodiment, the adjustment feature allows a user to manually adjust the preset flow time to desired value. The control module may comprise a reset feature configured to cause the solenoid to operate the valve to the open position. The reset feature may comprise a user operable actuator, such as a button or switch. In an embodiment, the control module may comprise a microprocessor to perform the logic described herein. In an embodiment, the control module may comprise discrete circuitry.

In accordance with an embodiment of the present disclosure, a method for preventing leaks in a fluid conveyance system is provided. The method may comprise providing power to a control module of a flow control device responsive to detecting flow of fluid in a fluid passageway, the control module having a timer. The method further comprises starting the timer to measure a flow time of the flow of fluid in the fluid line. The method further includes operating a leak control valve to a closed position using the control module if the flow time meets or exceeds a preset flow time. The method further comprises disconnecting power to the control module of the flow control device responsive to detecting no flow of fluid in the fluid line. The method may further comprise adjusting the preset flow time. The method may further comprise operating the leak control valve to an open position responsive to user input.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a perspective view of a flow control device installed onto a water supply line for a toilet in accordance with an embodiment of the present invention;

FIGS. 2 and 3 depict an electrical schematic of a flow control device in accordance with an embodiment of the present disclosure;

FIG. 4A is a flow diagram of a process for preventing leaks according to an embodiment of the present disclosure;

FIG. 4B is a flow diagram of a process for resetting a solenoid valve of a flow control module according to an embodiment of the present disclosure;

FIG. 5 is a diagram of a flow sensor according to an embodiment of the present disclosure; and

FIG. 6 depicts a hydrogenerator according to an embodiment of the present disclosure.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

For the purposes of promoting and understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

In describing and claiming the present disclosure, the following terminology will be used in accordance with the definitions set out below. As used in this specification and the appended claims, the singular forms “a,” “an,” and “the” include plural referents unless the context clearly dictates otherwise. As used herein, the terms “comprising,” “including,” “containing,” “characterized by,” “having,” and grammatical equivalents thereof are inclusive or open-ended terms that do not exclude additional, unrecited elements or method steps.

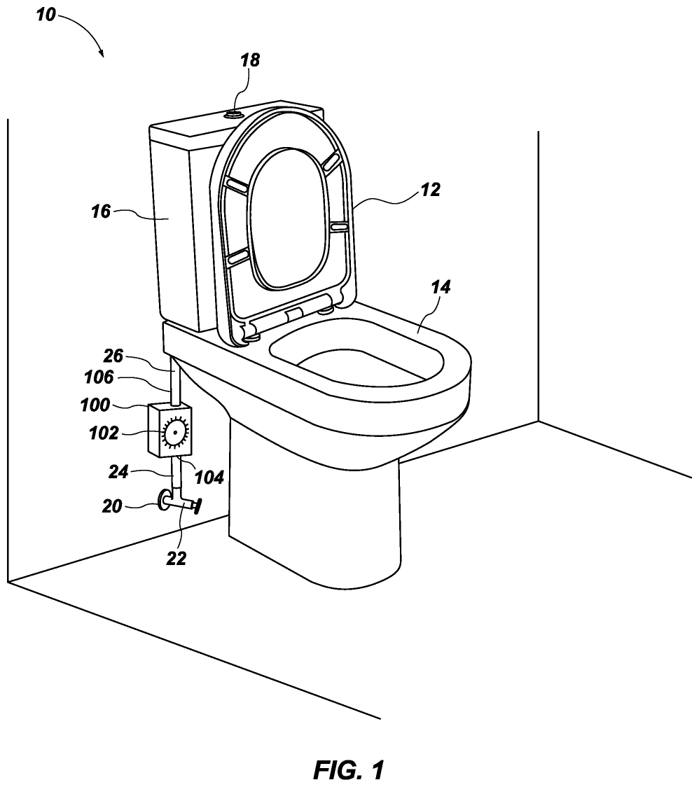

Referring now to FIG. 1, there is depicted a system 10 with a leak prevention feature. The system 10 may include a toilet 12. The toilet 12 may be of conventional design and include a bowl 14 and a tank 16. The tank 16 may supply water to the bowl 14 when the toilet 12 is flushed. The toilet 12 is flushed by a user depressing a lever 18. The lever 18 may be connected to a flapper valve by a lever chain inside of the tank 16. The flapper valve may be operable between an open position and a closed position. In the open position, the flapper valve allows water inside of the tank 16 to flow to the bowl 14 to effectuate a “flush.” In the closed position, the flapper valve prevents water inside of the tank 16 from flowing to the bowl 14. In particular, when the lever 18 is actuated during a flush event, the lever 18 may cause the flapper valve inside of the tank 16 to lift from an opening covering a fluid passageway leading to the tank 16. The water inside of the tank 16 then flows to the bowl 14 to complete the flush. When the tank 16 is empty, the flapper valve may close automatically.

The toilet 12 may further include a control valve inside of the tank 16 for controlling the flow of water into the tank 16. The control valve may be operable between an open position and a closed position. In the open position, the control valve allows water to flow into the tank 16. In the closed position, the control valve shuts off water flow to the tank 16. A float ball may be connected to the control valve by a lever arm. The float ball may float on the surface of the water inside of the tank 16. When the tank 16 is full, the float ball positions the lever arm such that the control valve is closed. When the toilet 12 is flushed, the float ball drops as water flows from the tank 16 to the bowl 14 such that the lever arm is positioned to open the control valve to allow water to flow into the tank 16. When the tank 16 is empty, the flapper valve drops to the closed position to allow the tank 16 to refill. When the tank 16 is full, the float ball is raised to a position to cause the lever arm to close the control valve and stop the flow of water into the tank. It will be appreciated that the control valve may operate automatically to fill the tank 16 using the float ball and lever arm.

The control valve is connected to a water supply 20 controlled by a turn valve 22. A first supply line 24 may lead from the turn valve 22 to a flow control device 100. A second supply line 26 may lead from the flow control device 100 to the control valve inside of the tank 16 through one or more intermediate connections. Water from the water supply 20 flows through the flow control device 100.

The flow control device 100 may include an inlet 104 connected to the first supply line 24 by a connector and an outlet 106 connected to the second supply line 26 by a connector. The flow control device 100 may include a fluid passageway extending between the inlet 104 and the outlet 106. As will be explained, the flow control device 100 may be utilized to automatically stop the flow of water to the control valve inside of the tank 16 from the water supply 20 if and when a leak condition is detected.

The flow control device 100 may also include a valve controlled by a solenoid. The valve may be operable between an open and closed position. In the open position, the valve allows water to flow from the water supply 20 to the tank 16. In the closed position, the valve prevents water from flowing from the water supply 20 to the tank 16. The flow control device 100 may include a control module for operating the valve between the open and the closed positions. In particular, when the control module detects a leak condition, it sends a signal to the solenoid to operate the valve to the closed position. To reopen the valve, a user may actuate an actuator on a user interface 102 on the flow control device 100.

It will be appreciated that toilets are known to leak for various reasons. The flapper valve is a rubber or plastic part that holds a seal to keep the water in the tank, a barrier between the tank and the bowl. Over time, the flapper valve can warp, crack, or break. If it does, it is no longer able to control water flow between the tank and bowl. Accordingly, water often leaks from the tank into the bowl. This leak is often silent making it difficult for users to detect. Flapper valves may also stick in the open position, allowing water to continually flow from the tank into the bowl. Leaks can also be caused by damaged tanks, bad or improperly adjusted float balls, and corroded or damaged control valves. As used herein, the term “leak condition” includes the flow of water beyond the intended normal operations of the fixture and/or the wasting of water.

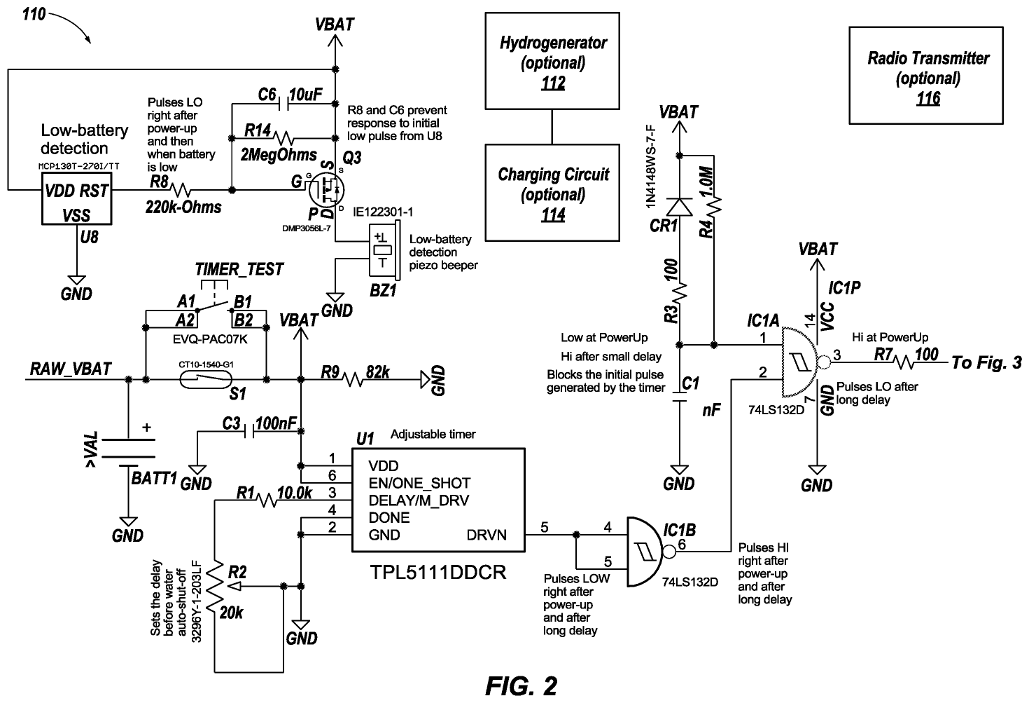

Referring to FIGS. 2 and 3, there is depicted a circuit diagram 110 of the electronics of a flow control device according to an embodiment of the present disclosure. To initially configure the circuit 110, the user presses and holds the TIMER_TEST button immediately after flushing the properly-working toilet. If LED_RG flashes red before the toilet has finished flushing and re-filling its tank, the user adjusts R2 to increase the delay-until-auto-shut-off time interval, eventually setting the interval so that LED_RG flashes red only after the toilet's flush cycle has ended. This procedure may be repeated a couple of times to select the best delay-until-auto shut-off time interval.

In the present circuitry, R2 can be adjusted to set the delay-until-auto-shut-off interval between 8 seconds and 2 minutes. Longer or shorter delay intervals can be provided by increasing or decreasing the rated value of component R2. For example, if the combined resistance of R1 and R2 is 57k-Ohms, the maximum delay interval is 10 minutes. In subsequent operation, a magnetic reed switch S1 will close and start the timer running when water starts flowing. If the water flows too long, the timer will reach the end of the delay until-auto-shut-off interval and close the solenoid valve, halting water flow. Typically, the delay until-auto-shut-off interval is just longer than the anticipated length of the flow during normal operation. For example, if the time of flow during a normal flush is 1 minute, the delay until-auto-shut-off interval may be 1 minute and 15 seconds.

In an embodiment, the behavior of the device's electronics is determined by the construction of the circuitry, rather than by any type of sequentially-executed program. This implementation was chosen to minimize power consumption, and to avoid issues with firmware crashing, flash memory fading and generation of electromagnetic interference. There is no clock signal. There is no flash memory or firmware, and no need for programming. The circuitry is an analog/digital hybrid implementation of an asynchronous state machine. While water is flowing and not activating the solenoid valve, the electronics draw very little current from the battery. When water is not flowing, no current is drawn from the battery.

As part of a flow detection mechanism, magnetic reed switch S1 closes when water is flowing, connecting raw battery power to the electronics. When water is not flowing, S1 is open, thus fully disconnecting the battery from all electronics and allowing maximum long-term battery life to be maintained. The TIMER_TEST momentary pushbutton switch allows the user to simulate the flow of water so the delay-until-auto-shut-off can be adjusted and observed. While pressed, this pushbutton connects raw battery power to the electronics. The delay-until-auto-shut-off is adjusted using multi-turn variable resistor R2. The end of the delay-until-auto-shut-off interval is indicated when LED_RG flashes red.

Immediately after raw battery power is connected to the electronics, adjustable timer U1 generates its very first low-going pulse, which must be ignored. U1 also samples the combined resistance of series-wired resistor R1 and potentiometer R2. U1 uses the sampled resistance value to set an internal counter that will determine the delay before its second low-going output pulse is generated. It is that second low-going output pulse that activates the solenoid valve to shut off the water. Dual-input Schmitt-trigger NAND gate IC1B logically inverts the output from timer U1. Thus, the output at IC1B pin 6 generates a high-going pulse immediately after power-up, which must be ignored. Another high-going pulse will be generated after the delay-until-auto-shut-off has elapsed. Capacitor C1 is discharged via resistor R3 and diode CR1 when power is not applied to the electronics. Thus, when power is first applied, IC1A input pin 1 is at logic-0, thus forcing IC1A output pin 3 to be at logic-1, thus causing the very first high-going pulse from IC1B pin 6 to be ignored.

With power applied, capacitor C1 gradually charges via resistor R4 until the voltage at IC1A pin 1 is at logic-1. By the time C1 has been charged, the very first high-going pulse from IC1B pin 6 will have come and gone, so IC1A pin 2 will be at logic-0. Thus, IC1A output pin 3 simply remains at logic-1 immediately following power-up, only pulsing to logic-0 later, after the delay-until-auto-shut-off has elapsed. Capacitor C2 is discharged via diode CR3 when power is not applied to the electronics. When power is first applied, both electrodes within C2 are at positive voltage VBAT. Thus, IC1C input pin 9 is initially at logic-1 and IC1C output pin 8 is initially at logic-0, as both inputs to IC1C will be at logic-1. Thus, when power is first applied, the gate of N-channel FET Q1 is at logic-0, so the FET is in the OFF state and the SOLENOID coil is not energized.

When the delay-until-auto-shut-off has elapsed, timer U1 generates its second low-going pulse, IC1B outputs a high-going pulse, and IC1A passes this second pulse by momentarily driving its output at pin 3 to logic-0. Capacitor C2 is quickly discharged via resistor R7 and diode CR2, driving IC1C input pin 9 to logic-0. When the timer pulse ends, IC1A pin 3 returns to a logic-1 state, but C2 re-charges slowly through resistor R6, thus maintaining the logic-0 at IC1C input pin 9 for a while, effectively stretching the low-going timer pulse. In response, IC1C output pin 8 remains at logic-1 longer than just the duration of the timer pulse, long enough to ensure that FET Q1 is turned ON long enough for the SOLENOID to pull into the water-shut-off position. The stretched pulse at IC1C output pin 8 ends once capacitor C2 has charged sufficiently to present a logic-1 voltage at IC1C input pin 9. SOLENOID is no longer driven by FET Q1 once the stretched pulse ends, thus conserving battery power. The SOLENOID is mechanically held in its watershut-off position until the coil is driven by battery power with polarity reversed, which happens when momentary pushbutton switch SW3 is pressed. The user can press SW3 to reset the SOLENOID to its open position, which is then mechanically maintained. An R-C snubber is implemented by capacitor C4 and resistor R12, used to suppress high voltage back-EMF from the solenoid coil when it is de-activated. An R-C snubber is used here instead of the typical fly-back diode because back-EMF suppression must occur when the solenoid is activated with either polarity.

LED_RG is a bi-color LED that shows green when the solenoid is reset to the open position and shows red when the solenoid automatically shuts off water flow. U8 generates a low-going pulse when first powered up, and subsequently outputs a continuous logic-0 when the battery voltage is at or below 2.7 Volts. Capacitor C6 is discharged through resistor R14 when power is not applied to the electronics. Thus, the gate terminal of Pchannel FET Q3 is at the same voltage as the source terminal immediately following power-up, and FET Q3 remains OFF. U8's initial low-going output pulse does not last long enough to charge C6 via resistor R8, so U8's initial pulse does not turn on FET Q3 and piezo buzzer Q3 remains silent. Thus, U8's initial output pulse is ignored.

While the electronics are powered up, U8 senses the battery voltage. If that voltage is at or below 2.7 Volts, U8's output goes low and stays that way long enough to charge capacitor C6 via R8, ultimately turning FET Q3 on and activating piezo buzzer BZ1. Thus, a user is alerted to a low-battery condition.

In an embodiment, the system may optionally include a hydrogenerator 112 for generating electricity to charge the energy storage device or power the control module. The hydrogenerator 112 may comprise a hydraulic turbine located in the water flow and that converts the energy of flowing water into mechanical energy. A hydroelectric generator connected to the turbine converts this mechanical energy into electricity to charge the energy storage device and/or power the control module. The hydrogenerator 112 may be connected to a charging circuit 114 for charging the energy storage device.

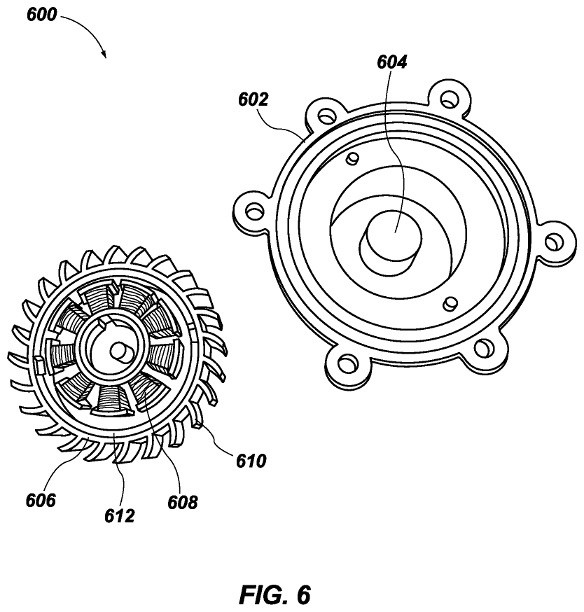

Referring to FIG. 6, there is depicted an embodiment of a hydrogenerator 600 according to an embodiment of the present disclosure. The hydrogenerator 600 may comprise a housing 602 having a water inlet and a water outlet (not shown). The housing 602 may comprise a shaft 604. A generator 608 may be mounted on the shaft 604. The generator 608 may be connected to a charging circuit (not) shown. A turbine 606 having blades 610 may rotate a magnet 612 about the generator 608 when water is flowing.

Referring back to FIGS. 2 and 3, in an embodiment, the present disclosure may optionally include a radio transmitter 116 for transmitting usage data captured by the control module. The control module may capture the water usage data and transmit it to a centralized database associated with a centralized server. In an embodiment, the radio transmitter may be one of a Bluetooth radio transmitter, a Wi-Fi radio transmitter, or a cellular transmitter (5G). The centralized server may process the data to determine optimal water usage and the number of times the device has stopped wasted water through leaks. The centralized server may analyze the usage date to optimize water flow and water usage.

As used herein, the term “control module” may refer to some or all of the electronics of the flow control device. In an embodiment, a control module includes the timer and the circuitry to send a control signal to the solenoid valve. Thus, implementations of a control module according to the present disclosure may not include the battery or the solenoid valve itself.

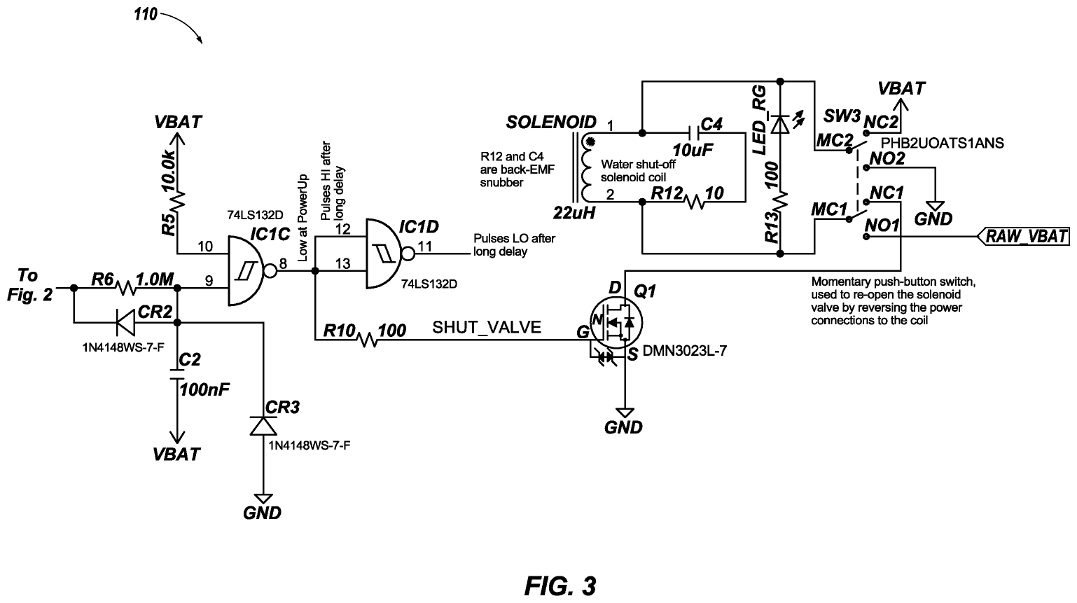

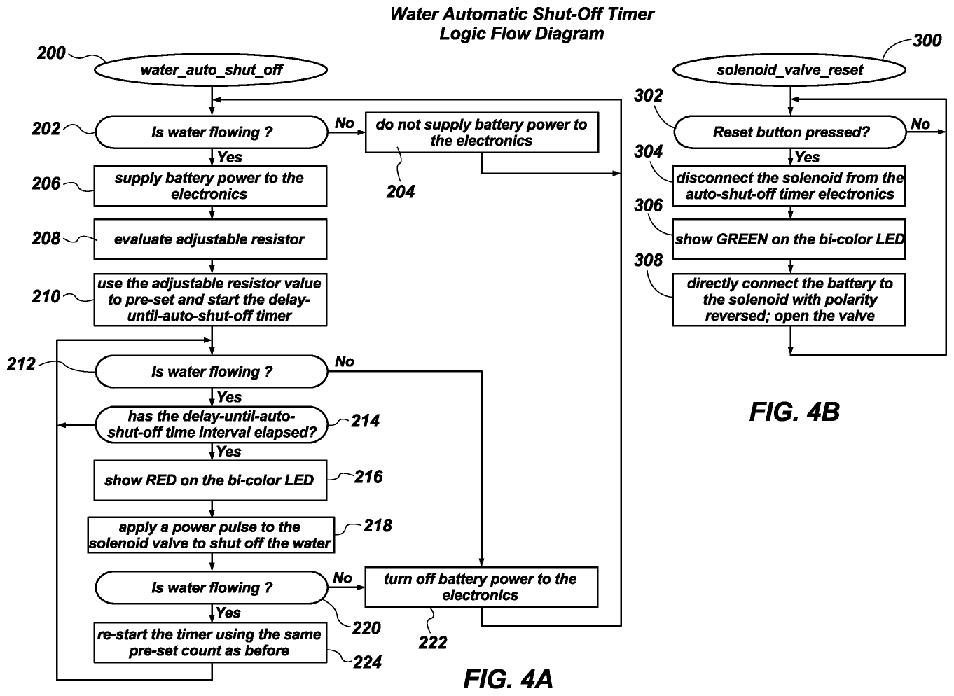

Referring now to FIG. 4A, there is depicted a process of a flow control device having a control module according to an embodiment of the present disclosure. The circuitry of the control module may take form depicted in FIGS. 2 and 3. At step 200, the water is not flowing, perhaps because a control valve in a fixture, such as toilet, is closed. At step 202, the flow control device determines if water is flowing. The water could be flowing due to the control valve of the fixture opening during normal operation or because of a leak condition. If water is not flowing, at step 204, no power is supplied to the control module. If water flow is detected, power is supplied to the electronics at step 206. At step 208, the value of the adjustable resister is evaluated. At step 210, the value of the adjustable resistor is used to pre-set and start the delay-until-shut-off timer.

At step 212, the process determines whether water is flowing. If no, power to the electronics is turned off or disconnected. If yes, at step 214, the process determines if the delay-until-auto-shut-off time interval has elapsed. If no, the process returns to step 212 to determine if water is still flowing. If yes, the red LED is turned on at step 216. Then, at step 218, a control signal is sent to the solenoid to close the valve. At step 220, the process determines if water is still flowing. If yes, at step 224 the timer is restarted and the process returns to step 212. If no, power to the electronics is turned off at step 222 and the process returns to step 202.

Referring now to FIG. 4B, there is shown a process for resetting the solenoid valve to the open position. At step 300, the solenoid valve is in the closed condition due to the detection of a leak condition. At step 302, the process determines if the reset button has been actuated. If no, the process loops back to step 302. If yes, at step 304, the solenoid is disconnected from the auto-shut-off-timer electronics. Then, at step 306 the green LED is turned on. Then, at step 308, the solenoid valve is operated to the open position. The process then loops back to step 302.

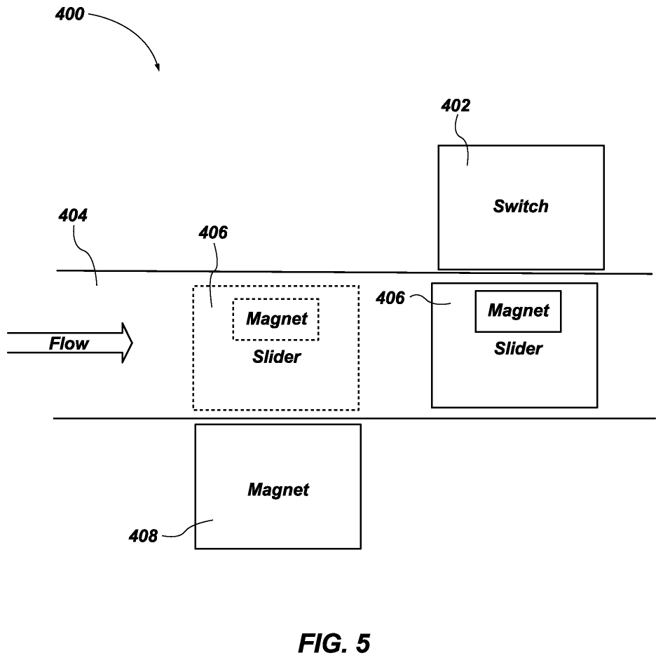

Referring to FIG. 5, there is depicted a flow sensor 400 according to an embodiment of the present disclosure. The sensor 400 may include a switch 402 adjacent a fluid passage 404. Disposed with the passage 404 is a slider 406 having a magnet. The slider 406 is operable between a first position (solid line) and a second position (dashed line). When fluid is flowing, the fluid pushes the slider 406 to the first position such that its magnet operates the switch 406 to a closed position such that the electronics of a flow control device are connected to power. When fluid is not flowing, a magnet 408 pulls the slider 406 to the second position such that the switch 402 opens to disconnect the electronics of a flow control device from power, Thus, it will be appreciated that the flow control device is only powered when fluid is flowing.

Similar implementations are possible without adding any programmable hardware. Obviously, the same functionality described above can be implemented using a microcontroller, FPGA, CPLD or other programmable device. The description provided here represents only one possible design approach. Of course, the use of programmable hardware as part of a control module allows additional functionality to be included. A device that automatically learns the correct behavior of an attached water appliance and subsequently detects abnormal performance is one such design variant. But, as explained above, the use of programmable hardware may shorten the battery life of the flow control device.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A flow control device for preventing leaks in a fluid conveyance system, comprising:
a housing having a fluid inlet and a fluid outlet;
a fluid passageway extending between the fluid inlet and the fluid outlet;
a valve disposed in said fluid passageway, said valve operable between a closed position and an open position, wherein said valve prevents flow of fluid in the fluid passageway when operated to the closed position and wherein said valve permits flow of fluid in the fluid passageway when operated to the open position;
a solenoid connected to said valve and configured to operate the valve between the open position and the closed position;
a control module in electrical communication with said solenoid, said control module configured to send control signals to said solenoid to operate the valve to the closed position;
an energy storage device providing power to said control module;
a switch electrically interposed between said energy storage device and said control module, said switch operable between an open position and a closed position, wherein the energy storage device is disconnected from the control module while the switch is in the open position and the energy storage device is connected to the control module while the switch is in the closed position; and
a flow sensor for operating the switch to the closed position in response to fluid flow in the fluid passageway to thereby allow the energy storage device to provide power to the control module only while the fluid is flowing.

2. A flow control device in accordance with claim 1, wherein the energy storage device is a battery.

3. A flow control device in accordance with claim 1, wherein the switch is a magnetic switch.

4. A flow control device in accordance with claim 1, wherein the control module comprises a flow timer configured to monitor a flow time of fluid in the fluid passageway.

5. A flow control device in accordance with claim 4, wherein the control module is configured to cause the solenoid to close the valve responsive to the flow time equaling or surpassing a preset flow time.

6. A flow control device in accordance with claim 5, wherein the control module comprises an adjustment feature for adjusting the preset flow time.

7. A flow control device in accordance with claim 6, wherein the adjustment feature automatically adjusts the preset flow time based on historical flow times.

8. A flow control device in accordance with claim 6, wherein the adjustment feature allows a user to manually adjust the preset flow time based on historical flow times.

9. A flow control device in accordance with claim 1, wherein the control module comprises a reset feature configured to cause the solenoid to operate the valve to the open position.

10. A flow control device in accordance with claim 9, wherein the reset feature comprises a user operable button.

11. A flow control device in accordance with claim 1, wherein the control module comprises a microprocessor.

12. A method of controlling leaks in a fluid conveyance system, said fluid conveyance system comprising a fluid line between a source and a control valve, said method comprising:
installing a flow control device in the fluid line between the source and the control valve, said flow control device comprising:
a housing having a fluid inlet and a fluid outlet,
a fluid passageway extending between the fluid inlet and the fluid outlet,
a valve disposed in said fluid passageway, said valve operable between a closed position and an open position, wherein said valve prevents flow of fluid in the fluid passageway when operated to the closed position and wherein said valve permits flow of fluid in the fluid passageway when operated to the open position,
a solenoid connected to said valve and configured to operate the valve between the open position and the closed position,
a control module in electrical communication with said solenoid, said control module configured to send control signals to said solenoid to close said valve,
an energy storage device providing power to said control module,
a switch disposed between said energy storage device and said control module, said switch operable between an open position and a closed position, wherein the energy storage device is disconnected from the control module while the switch is in the open position and the energy storage device is connected to the control module while the switch is in the closed position, and
a flow sensor for operating the switch to the closed position in response to fluid flow in the fluid passageway to thereby provide power to the control module.

13. A method in accordance with claim 12, wherein the energy storage device is a battery.

14. A method in accordance with claim 12, wherein the switch is a magnetic reed switch.

15. A method in accordance with claim 12, wherein the control module comprises a flow timer configured to monitor a flow time of fluid in the fluid passageway.

16. A method in accordance with claim 15, wherein the control module is configured to cause the solenoid to close the valve responsive to the flow time equaling or surpassing a preset flow time.

17. A method of controlling leaks in a fluid conveyance system, said fluid conveyance system comprising a fluid line extending between a source and a control valve, the fluid line having a leak control valve controlled by a solenoid interposed between the source and the control valve, said method comprising:
providing power to a control module of a flow control device responsive to detecting flow of fluid in the fluid line, the control module having a timer;
starting the timer to measure a flow time of the flow of fluid in the fluid line;
operating the leak control valve to a closed position using the control module if the flow time meets or exceeds a pre-set flow time; and
automatically disconnecting power to the control module of the flow control device when there is no flow of fluid in the fluid line.

18. A method in accordance with claim 17, further comprising adjusting the pre-set flow time.

19. A method in accordance with claim 17, further comprising operating the leak control valve to an open position responsive to user input.

20. A method in accordance with claim 17, wherein the control valve controls fluid flow into a fluid storage tank.
